(19) United States
(12) Patent Application Publication
(10) Pub. No.: US 2011/0202595 A1
(43) Pub. Date: Aug. 18, 2011

(54) AT-DESK MANAGEMENT SYSTEM, APPARATUS, AND TERMINAL

(75) Inventor: HIROYUKI KAKIUCHI, Kawasaki (JP)

(73) Assignee: Hitachi, Ltd.

(21) Appl. No.: 12/974,930

(22) Filed: Dec. 21, 2010

(30) Foreign Application Priority Data
Feb. 15, 2010 (JP) 2010-029660

(51) Int. Cl. G06F 15/16

(52) U.S. Cl. 709/203

(57) ABSTRACT

An at-desk notice system includes plural clients, and a server. Each of clients includes a notice display unit for displaying at-desk notice information on a monitoring-target user, and a state notice unit for notifying the server of a change in state information on a user of the client. The server includes a judgment unit for determining whether the state information, the change of which is notified by the clients, has changed to an at-desk state and whether the change-notified user is monitored by other user, and a notice unit for issuing, to the client of the other user, a notice that the monitoring-target user becomes the at-desk state.

### INCORPORATION BY REFERENCE

The present application claims priority from Japanese application JP 2010-029660 filed on Feb. 15, 2010, the content of which is hereby incorporated by reference into this application.

### BACKGROUND OF THE INVENTION

The present invention relates to an at-desk management system, apparatus, and terminal for notifying the at-desk information on a user of the monitoring target.

In recent years, there has occurred a significant innovation in the intra-enterprise work style as well. This significant innovation, which is a work style referred to as “free address”, has developed from the progresses in network system and communications appliances the representative of which is an IP telephone. In this free-address work style, no fixed desk is prepared for each employee. Namely, each employee is allowed to do his or her work at an arbitrary desk every day. For example, depending on his or her mood on the day, or a business-operation project concerned, each employee can change the desk freely. As a consequence, the layout-free office style becomes available.

In an office into which this free-address work style is introduced, however, there has appeared the following new problem. Namely, it has become more or less difficult to recognize at which desk who is seated. The reason for the occurrence of this difficulty is as follows: Namely, as long as the office base concerned is this free-address work style office base, each employee can perform a business operation in basically the same way, even if the floor or building at which each employee is present differs from each other. In order to solve a problem like this, there exist embodiments of the at-desk management system disclosed in JP-A-2007-335923 (corresponding to US2007/286208A1) and JP-A-2008-140295 (corresponding to US2008/134301A1).

The technology disclosed in JP-A-2007-335923 is as follows: Based on terminal connection information on a terminal managed by a network appliance such as LAN switch, this technology makes it possible to solve at which desk a person should be who is going to use this terminal. Moreover, this technology allows the solution result to be displayed on a graphic chart. The technology disclosed in JP-A-2008-140295 is as follows: In solving the desk position of a person who is going to use a terminal, with respect to a co-use terminal which is co-used by a plurality of users, this technology also makes it possible to identify the desk positions of the users by taking advantage of the user identifiers. Based on these technologies, like, e.g., FIG. 9 in JP-A-2007-335923, merely taking a look at the displayed diagram permits the user to recognize at which desk who is at a glance. This successful result makes it possible to solve the above-described problem.

Consideration is given to an at-desk management system that takes advantage of technologies the representatives of which are the above-described publicly-known embodiments. In this at-desk management system, in the free-address work style office base as well, if an employee is seated at a desk which he or she likes, and connects the desk terminal such as a PC to the LAN, this connection position is displayed on the graphic chart. Then, by merely taking a look at this graphic chart even a person who is present at another office base away from this one is permitted to grasp at which desk who is seated.

Also, each PC is equipped with a function of detecting the state (such as, e.g., log-in state, screen-saver state, or power-supply ON/OFF state) of its own PC, and notifying a server of the detected state automatically. For example, if the detected state is the log-in state, the user who has logged in to the PC is interpreted as being “at desk” at the PC-set-up position. If the detected state is the screen-saver state, the user is interpreted as being “not at desk” in a state where the user should do the work right now, but is away from the desk temporarily, or in a state where the user is at desk right now, but does not use the PC since he or she is engaged in some other task. In this way, the detected state is interpreted as the roughly-interpreted states, then being displayed on the graphic chart. Then, by merely taking a look at this graphic chart, another person is permitted to recognize the desk position of this user and his or her state, although the accuracy is not equal to 100%.

Based on this function of each PC with the use of the interpretation and display, for example, when a user has checked the graphic chart in trying to give a telephone call to a target employee, if the display of this employee is found to be the “not at desk” state, the user can make the following judgment or the like: “Even if I call the employee right now, the employee is quite likely to be away from the desk. So, I'd better wait for a while until the display turns to the “at desk” state, and then call.”

Meanwhile, the so-called presence management systems, which are capable of managing/browsing the state of a user (i.e., presence information), have been developed in various cases. Of these systems, as the system capable of notifying that the presence information has become a particular state, there exists an embodiment disclosed in JP-A-2008-17363.

The technology disclosed in JP-A-2008-17363 is as follows: For example, a user has registered the following condition into a server in advance: Namely, in this condition, the user wishes that, if a particular user has entered a conference room, a notice to the effect should be issued to the user. Meanwhile, a position measurement system measures the position of a terminal of the particular user, then notifying the server of the measured position. Moreover, the server makes a condition judgment on the change in the physical position information as to whether or not the terminal of the particular user has entered the conference room. Then, if the condition is found to hold, the notice is issued to the above-described condition registrant.

Also, meanwhile, as one technology of the presence management systems for managing the above-described presence information, there exists the technology disclosed in JP-A-2006-243966. In this technology, when the presence information cannot be inputted automatically, or when the presence information is not inputted by the user manually, the presence information is compensated by establishing a mutual cooperation with a schedule management apparatus.

The technology disclosed in JP-A-2006-243966 is as follows: When the presence information is not made available by causes such as an off-line state, if the present schedule has been described on the schedule management apparatus, this information on the present schedule is fetched, then being made displayable as the presence information. This processing is implemented by establishing the mutual cooperation with the schedule management apparatus.

### SUMMARY OF THE INVENTION

In the utilization of the at-desk management system, if a target person, with whom a user is going to make contact, is found to be “absent” or “not at desk”, the user should continue to monitor the graphic chart all the while until the target person has come back to his or her desk (“at desk” state). This is a very laborious task. Then, consideration is given to a case where the technology disclosed in JP-A-2008-17363 is applied and used here. In this case, if it is possible to specify the position of the absent target person, such as a determined conference room, or his or her own desk whose location is determined in advance, this position is specified in advance. Based on this in-advance specified position, if the position of a terminal which the absent target person possesses has entered this in-advance specified position, it becomes surely possible to issue the notice.

In the following cases, however, there exists a problem that it is impossible to specify the position of a target person in the registration of the judgment condition on the notice. In the case of a free-address workplace or the like where the location of each employee's own desk is not determined, or in the case of a company which has a plurality of office bases in the local area, and where it is unknown to which of the office bases a target employee is supposed to go to work, or the like.

Also, when a target person is “not at desk”, and if the terminal capable of identifying the position of the target person is a PC alone, the change in the physical position information on the terminal cannot be detected. This case occurs when, for example, the target person has gone to a rest room just a while, and has gotten back to the desk. Accordingly, there exists a problem that it is impossible to notify that the target person has gotten back to the desk.

Also, at present, there have appeared a large number of offices each of which is separated by a partition, a large number of vast offices, and free-address offices. In an actual situation like this, there also exists the following problem. Only the specification of a rough range measured using a wireless LAN or the GPS is not necessarily effective enough to accurately determine whether the target person has really gotten back to his or her own desk, or the target person has merely crossed the desk in order to go to the next conference room.

Namely, the problem on which the present application focuses its attention is as follows: Even if the notice is issued to the user after detecting the change in the physical position information on the terminal which the target person possesses, “a change in the state of the target person” becomes necessary in order to determine “the next action” to be taken by the user, such as, e.g., going to the target person's desk to meet him or her directly, giving a telephone call to the person, or sending a mail thereto. Conventionally, it has been executable to notify the roughly-specified physical position acquired using the GPS and the like. There has existed, however, none of a unit or method for accurately notifying with what type of action the user can make contact with the target person in the state where the very target person is right now.

Furthermore, when the at-desk management system and the notice technology disclosed in JP-A-2008-17363 are combined with each other, the notice can be issued to the user to the effect that the specified condition has been found to hold. There also exists a problem, however, that this combination fails to pursue and implement the convenience for the user which leads to the determination of “the next action” to be taken by the user when the notice is issued to the user.

A concrete example of this problem will be given below: From a purpose that the user wishes to make contact with Mr. A immediately when Mr. A comes back to his own desk, the user registers the following notice condition into the server: Namely, in this condition, the user wishes that, if Mr. A comes back to his own desk position, the notice to the effect should be issued to the user. After a while, when Mr. A comes back to his own desk, the change in the physical position information disclosed in JP-A-2008-17363 is detected. Then, a message to the effect that Mr. A has gotten back to his own desk is transmitted to, a user's mobile telephone. However, when the user has received the message, and is going to make contact with Mr. A actually, the user should search for Mr. A's telephone number from a mobile telephone's address note in order to give a telephone call to Mr. A, or the user should search for Mr. A's extension number from a nearby extension telephone in order to give the telephone call Mr. A. This is a significantly inconvenient task.

The user has set the registration of the notice condition with the purpose that the user wishes to make contact with the target person. Accordingly, it is conceivable that, if it were possible to indicate a method or information which leads to the determination of the next action immediately after the user has received the notice, it would become possible to provide a more user-friendly notice function. No proposal, however, has been made concerning a system where the assumption is made up to this stage.

Next, in the utilization of the at-desk management system, if a target user is absent, the target user has been not displayed on whichever graphic chart. Otherwise, when the target user is retrieved by using the system, detailed information on the target user has been displayed. Then, information saying <at-desk location=“absent”> has only been displayed.

In view of this situation, the technology disclosed in JP-A-2006-243966 is integrated into the at-desk management system. As a result of this integration, if e.g., <10 o'clock to 12 o'clock, visit company A> is registered into the schedule management apparatus, information saying <at-desk location=“visit company A”> can be displayed between 10 o'clock and 12 o'clock. Accordingly, when a user, wishing to make contact with the target user, uses the at-desk management system, it becomes possible to provide the more concrete information.

In the above-described combined technology, the user finds it possible to recognize the information saying <visit company A> from 10 o'clock to 12 o'clock. There has existed a problem, however, that the user finds it impossible to recognize the after-12 o'clock information, unless it is past 12 o'clock actually.

In this case, the user finds it impossible to grasp whether the target user will come back to the company immediately after 12 o'clock, or will visit company B afterwards, unless it has elapsed to the very time actually. Consequently, there has existed a problem that the user finds it impossible to promptly make a judgment, such as “The target user will come back to the company immediately after 12 o'clock. So, I'd better wait for a while.”, or “The target user will have the schedule afterwards, too. Then, why don't I send only the business by mail?”.

Namely, when the target user is retrieved in the utilization of the at-desk management system, if the target user is absent, the integrated use of the state of being absent and the technology disclosed in JP-A-2006-243966 makes it possible to display the information which is recorded into the schedule management apparatus at the present time (i.e., just now). There exists a problem, however, that, if the user wishes to take a look at the from-now-on schedule or the immediately-before schedule, the user finds it impossible to acquire this target information at once.

In view of the above-described problems, in the utilization of the at-desk management system, an object of the present invention is to provide a notice method in which, when a target person is in the not-at-desk state or the absent state, attention is focused not only on a change in the physical position of the target person, but also on “a change in the state of the target person”. Another object is to provide a method or information which leads to the determination of the next action to be taken by the user when the user receives the notice. Still another object is to provide a communications system wherein the concept that the presence information displays information at present is advanced one step ahead, and whereby it becomes possible to provide by one stop the from-now-on schedule of the target contact person as well as the immediately-before schedule thereof.

In order to solve at least one of the above-described problems, in the present invention, there is provided an at-desk notice system including a plurality of clients, and a server, wherein each of the plurality of clients includes a notice display unit for displaying at-desk notice information on a monitoring-target user, and a state notice unit for notifying the server of a change in state information on a user who uses the client, the server including a judgment unit for judging whether the state information, the change of which is notified by one of the clients, has changed to an at-desk state and whether a user of the change-notified client is monitored by other user, and a notice unit for issuing, to the client of the other user, a notice that a monitoring-target user becomes the at-desk state.

According to the present invention, it becomes possible to provide the function of notifying not only a change in the physical position information on the to final of a target person, but also “a change in the state information on the target person” for allowing the user to determine “the next action” accurately.

Other objects, features and advantages of the invention will become apparent from the following description of the embodiments of the invention taken in conjunction with the accompanying drawings.

### BRIEF DESCRIPTION OF THE DRAWINGS

FIG. 1 is a basic communications system configuration diagram for carrying out a first embodiment;

FIG. 2 is a logic function diagram for carrying out the first embodiment;

FIG. 3 is an example 1 of the notice-registration screen interface for carrying out the first embodiment;

FIG. 4 is an example 2 of the notice registration screen interface for carrying out the first embodiment;

FIG. 5 is a diagram for illustrating the contents of a table stored into a notice registration DB 211;

FIG. 6 is a flowchart for illustrating a processing flow performed by a notice registration unit 212 for carrying out the first embodiment;

FIG. 7 is a flowchart for illustrating a processing flow performed by a notice judgment unit 209 for carrying out the first embodiment;

FIG. 8 is a flowchart for illustrating a processing flow performed by a notice transmission unit 210 for carrying out the first embodiment;

FIG. 9 is an example of the message screen interface for carrying out the first embodiment;

FIG. 10 is a sequence for the utilization scene explained in the first embodiment;

FIG. 11 is a basic communications system configuration diagram for carrying out a second embodiment;

FIG. 12 is an example of the message screen interface for carrying out the second embodiment;

FIG. 13 is a basic communications system configuration diagram for carrying out a third embodiment;

FIG. 14 is an example of the screen interface for carrying out the third embodiment; and

FIG. 15 is an example of the message screen interface for carrying out the third embodiment.

### DESCRIPTION OF THE INVENTION

### Embodiment 1

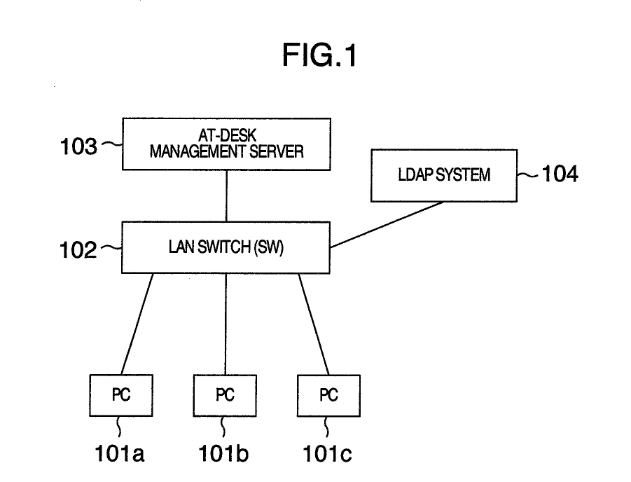

Hereinafter, based on the accompanying drawings, the explanation be given below concerning embodiments of the present invention. FIG. 1 is a basic communications system configuration diagram for carrying out the present first embodiment. A PC 101a to a PC 101c are connected to a LAN switch (which, hereinafter, will be abbreviated as “SW”) 102. Also, an at-desk management server 103 and a LDAP (Lightweight Directory Access Protocol) system 104 are connected to the SW 102.

The SW 102, which has a packet-transferring function, is equipped with a management information base abbreviated as “MIB (Management Information Base)”. The information stored in the MIB can be acquired by the other appliances, using SNMP (Simple Network Management Protocol).

The at-desk management server 103 manages the position relationship between desks and the PCs 101. Namely, the server 103 receives, from a PC 101, the notice of a change in the state information on its user. Moreover, the server 103 notifies a change in the state information on another user (e.g. another user is seated at a desk) who is using another PC 101. For this purpose, the server 103 receives, from a certain PC 101, a change in the state information periodically or whenever the change in the state occurs.

The LDAP system 104 is a DB for storing the names and affiliation information on employees. The detailed information related therewith can be acquired such that the employee IDs for identifying the employees uniquely are used as the keys.

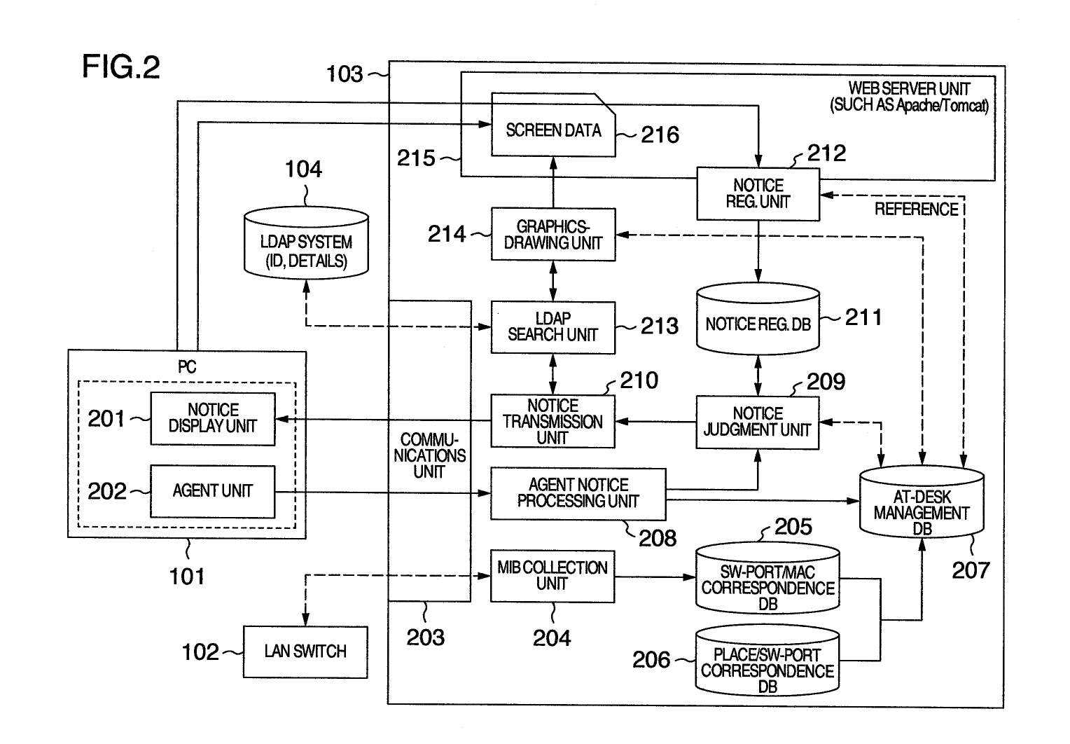

FIG. 2 is a function block diagram for carrying out the present first embodiment.

Each PC 101 includes a notice display unit 201 for receiving, from the at-desk management server 103, a change in the state information on a monitoring-target user who is using a certain PC 101, and displaying the change which the unit 201 has received, and an Agent unit 202 for notifying the change in the state information on a user who uses the PC 101.

The Agent unit 202 acquires and transmits, to an Agent notice processing unit 208, the MAC address of the PC 101, the employee ID of an employee who is using the PC 101, and the utilization state (i.e., status) of the PC 101. The employee ID of the employee who is using the PC 101 refers to an ID such as the log-in ID of the PC 101. Accordingly, it is assumed that the employee ID is used as the log-in ID here.

Also, the utilization state refers to values indicating operating situations or running situations acquirable inside the PC 101, such as, e.g., log-in state, screen-saver state, power-supply ON/OFF state, softphone-based calling state, and state where constant-time-period key input or mouse input continues. Here, for simplicity of the explanation, the following embodiment will be described: Two states are acquirable, i.e., the log-in state defined as “status=1” and the screen-saver state defined as “status=2”. Moreover, on the display base, an assumption is made such that “1 (log-in state)=at desk”, “2 (screen-saver state) not at desk”, and “0 (power-supply OFF state)=absent”.

The notice display unit 201 exhibits a function of displaying, onto the screen, notice information transmitted from a notice transmission unit 210 which will be described later. When the notice display unit 201 receives the notice information from the notice transmission unit 210, the unit 201 creates a message-displaying window, thereby outputting the message onto the screen.

The at-desk management server 103 includes a communications unit 203, a MIB collection unit 204, a SW-port/MAC correspondence DB 205, a place-SW/port correspondence DB 206, an at-desk management DB 207, the Agent notice processing unit 208, a notice judgment unit 209, the notice transmission unit 210, a notice registration DB 211, a notice registration unit 212, a LDAP search unit a graphics-drawing unit 214, and a Web server unit 215.

The communications unit 203 is a function unit for performing the communications performed by the at-desk management server 103 via the network.

Next, the explanation will be given below concerning the position relationship between the desks and the PCs 101.

Using the above-described SNMP, the MIB collection unit 204 periodically collects SW-port/MAC correspondence information from the SW 102 via the communications unit 203, then storing this SW-port/MAC correspondence information into the SW-port/MAC correspondence DB 205. The correspondence relationship between the places (i.e., desks) and the SW ports is memorized in advance into the place/SW-port correspondence DB 206. By taking advantage of the SW-port/MAC correspondence DB 205 and the place/SW-port correspondence DB 206, it becomes possible to know the relation between the desks and the PCs 101.

Concretely, the SW-port/MAC correspondence DB 205 stores therein the correspondence information between the “SW-ID & SW-port” and “MAC address” acquired from the SW 102. This correspondence information specifies the SW and the port number of the SW to which the MAC address X connects.

The place/SW-port correspondence DB 206 stores therein the correspondence information between the “SW-ID & SW-port” and “place name” defined in advance. This correspondence information indicates the place-name information on the SW and the port number of the SW to which the desk X corresponds.

Next, the explanation will be given below regarding a function for displaying an at-desk state chart.

The graphics-drawing unit 214 causes the information in the at-desk management DB 207 and the information in the LDAP system 104 to be related with each other, thereby creating screen data on the at-desk state chart. The Web server unit 215 is a function unit for causing the screen data, which is created by the graphics-drawing unit 214, to be displayed using the WWW (World Wide Web) technology. The combined integration of the Web server unit 215 and the graphics-drawing unit 214 may also be defined as a screen-displaying function unit.

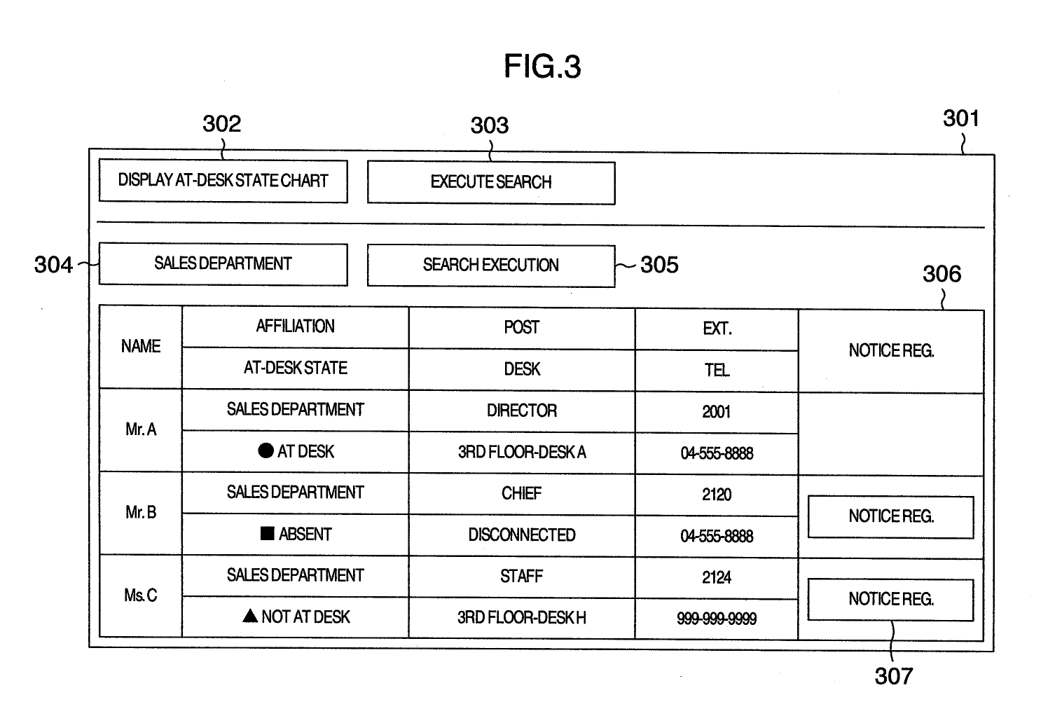

The LDAP search unit 213 is a function unit for receiving a search request from a different function unit, and carrying out the search for the employee information with respect to the LDAP system 104. As will be described later in FIG. 3 and FIG. 3, taking advantage of this function allows a user to specify a target user whose notice is wished to be received by the user.

Next, the explanation will be given below concerning the collection of the state information.

The Agent notice processing unit 208 receives the notice of the change in the state information from the Agent unit 202 of the PC 101 via the communications unit 203, then storing this information into the at-desk management DB 207. Also, the unit 208 passes over this information to the notice judgment unit 209 as well, which will be described later. The at-desk management DB 207 stores therein the following pieces of information in a manner of being related with each other: The at-desk place information (i.e., “MAC address”=“at-desk place name”) derived from the SW-port/MAC correspondence DB 205 and the place/SW-port correspondence DB 206, the MAC address of a terminal which is passed over from the Agent notice processing unit 208 and at which the Agent is present, the employee ID of an employee who is using this terminal, and the PC utilization state of this employee.

Incidentally, the detailed explanation will be given later regarding the notice judgment unit 209, the notice transmission unit 210, the notice registration DB 211, and the notice registration unit 212.

FIG. 3 is a first example of the notice-registration screen interface for carrying out the present first embodiment. The present screen interface is stored into the Web server unit 215 as screen data 216. A registration screen 301 is displayed using the screen interface such as a display of the PC 101. The screen data may also be partially stored in advance into a memory medium such as the memory of the PC 101.

On the registration screen 301, inputting a search key into a text box 304, and pushing down a search execution button 305 executes the search, thereby displaying a search result 306. If the at-desk state is found to be “not at desk” or “absent” in the search result 306, a notice registration button (“notice reg” in the drawings) 307 is displayed. Moreover, pushing down the notice registration button 307 passes over the registration information to the notice registration unit 212.

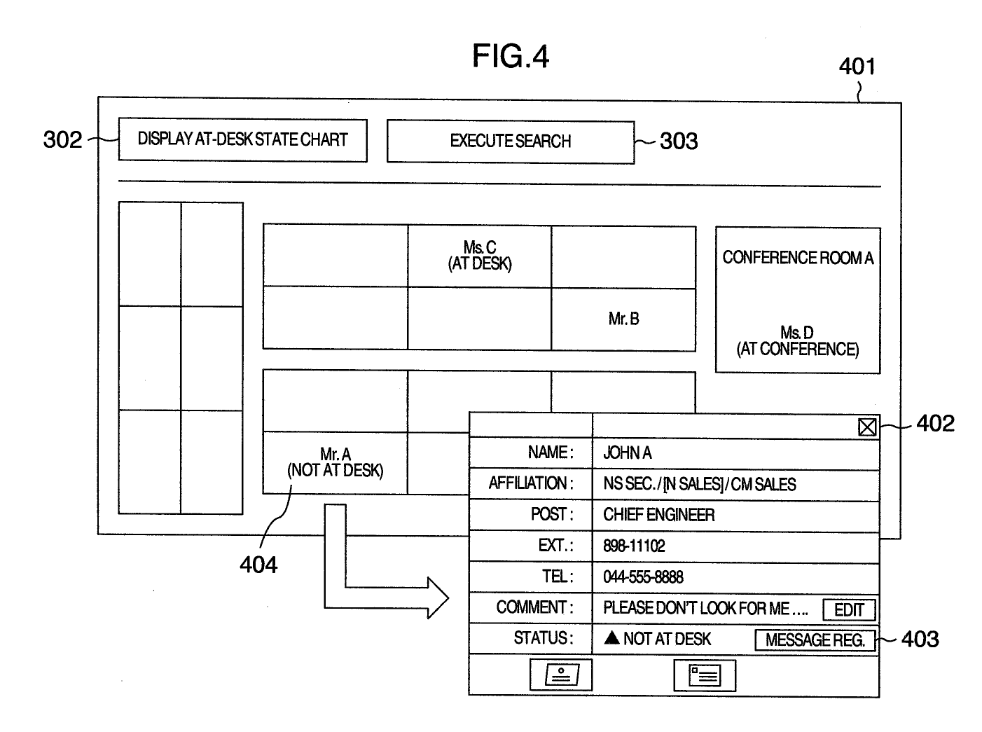

Also there exist a at-desk state chart displaying button 302 for displaying an at-desk state chart 401 (which is also referred to as “floor map”) in FIG. 4, and a search-screen displaying button 303 for displaying the search screen in FIG. 3. The use of these buttons allows the switching between the screens. The search may also be executed with the floor map remaining displayed.

Next, using a concrete example, the explanation will be given below concerning the notice-registration screen interface. Consideration is given to a case where a user wishes to make contact with Mr. B of a sales department with a timing when Mr. B comes back to the company, and is seated at a desk. In this case, the user inputs “sales department” into the text box 304, then pushing down the search execution button 305. As a consequence, a list of the sales department is displayed in the search result 306. Then, checking the at-desk state of “Mr. B” out of the search result 306 allows a confirmation that the at-desk state is “absent”. Accordingly, pushing down the notice registration button 307 of Mr. B allows the execution of the notice registration.

FIG. 4 is a second example of the notice-registration screen interface for carrying out the present first embodiment. The point in which FIG. 4 differs from FIG. 3 is a feature that, as the at-desk state chart 401, desks on the floor are displayed. This feature permits a user to visually find out a target person whom the user wishes to search for.

Concretely, the desk 404 of Mr. A who is not at desk is selected by, e.g., clicking on the desk 404 using a mouse's cursor. This operation allows implementation of the display of a detailed information screen 402. As a consequence, pushing down a notice registration button 403 allows the execution of the notice registration. Incidentally, the notice registration may also be made at the time when the desk portion of Mr. A was selected.

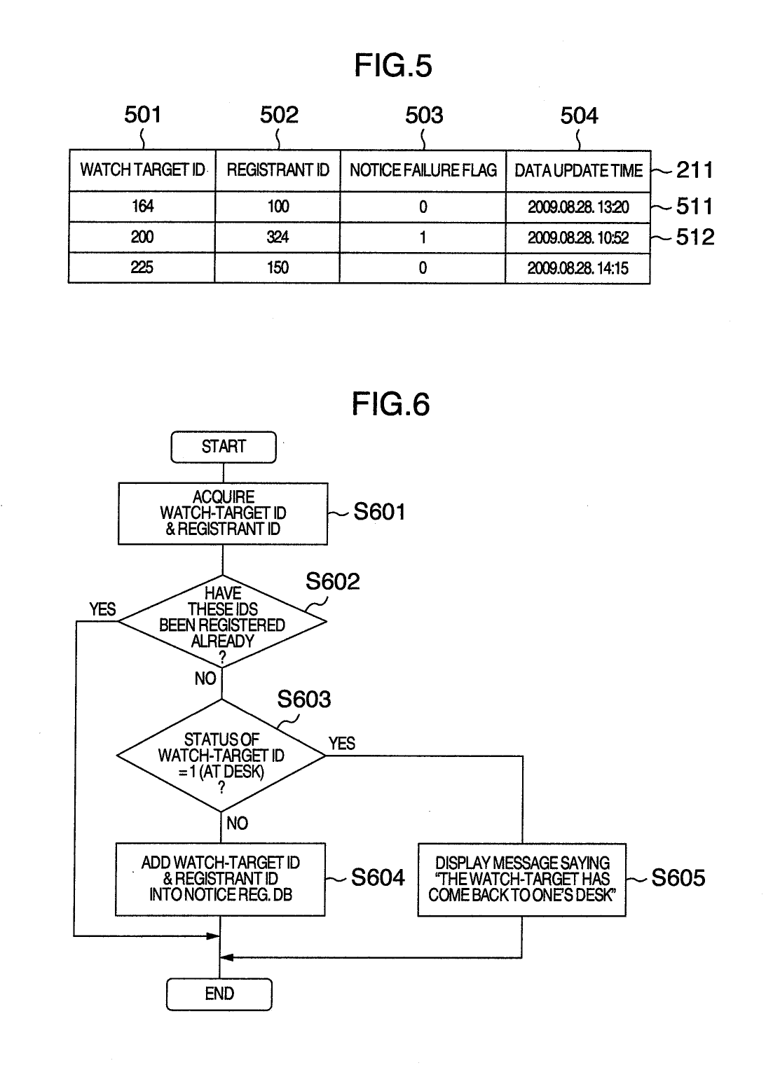

FIG. 5 is a diagram for illustrating the contents of a table stored into the notice registration DB 211. The notice registration DB 211 is a table for describing, on a one-to-one correspondence basis, the employee ID (=watch target ID 501) of a target person whose notice is wished to be received by a notice registrant, the employee ID (=notice registrant ID 502) of the notice registrant, a notice failure flag 503, and a data update time 504. Namely, at a row 511, the following situation is described: A person with <employee ID “100”> had made a notice registration of a person with <employee ID “164”> at <a data update time “2009. 08. 28. 13:20”>. At a row 512, the following situation is described. To an employee ID<324> of the notice registrant of the record, the notice transmission unit 210 issued a notice to the effect that a watch target ID<200> had been updated into the at-desk state. This notice, however, has not arrived at the notice registrant for some cause or other. In this case, the unit 210 changes the notice failure flag 503 to <1>, then terminating the processing. With respect to a record whose notice failure flag 503 is <1>, the notice transmission unit 210 tries to reissue the notice for every constant time-interval.

FIG. 6 is a processing flow performed by the notice registration unit 212 for carrying out the present first embodiment. The notice registration unit 212 is a processing function unit for allowing the present function user (i.e., notice registrant) to register the employee ID (=watch target ID 501) of a target person whose notice is wished to be received by the present function user. The present function user registers the employee ID of the present function user and the watch-target employee ID. The registration is made via the notice-registration screen interface illustrated in FIG. 3 or FIG. 4.

The present processing flow is started when the notice registration button 307 or 403 is pushed down on the notice-registration screen interface. At a S601, the employee ID of the registrant, who has pushed down the notice registration button 307 in FIG. 3 or the notice registration button 403 in FIG. 4, and the watch target ID are acquired from the Web server unit 215.

At a S602, it is judged whether or not the set of the registrant ID and the watch target ID has been registered already. If the set has been registered already (S602: Yes), the processing flow is terminated. Meanwhile, if not (S602: No), at a S603, reference is made to the notice registration DB 211 thereby judging whether or not the coincidence condition of “status of the watch target ID=1 (i.e., at desk)” holds. If this coincidence holds (S603: Yes), at a S605, a message to the effect that the watch target has been in the at-desk state already is displayed on the registration screen 301 or 401. Meanwhile, if not (S603: No), at a S604, <registrant ID>, <watch target ID>, <notice failure flag=0>, and <data update time> are registered into the notice registration DB 211, then to mating the present processing flow.

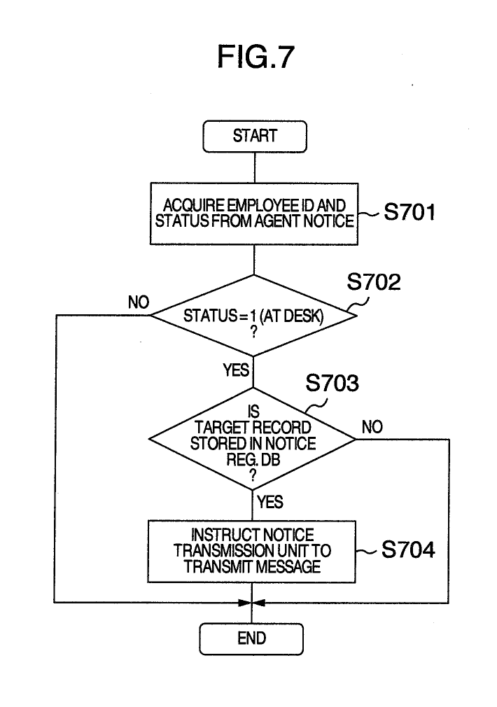

FIG. 7 is a processing flow performed by the notice judgment unit 209 for carrying out the present first embodiment. The notice judgment unit 209 is a processing function unit for receiving the notice information on the change in the state information from the Agent notice processing unit 208, and judging whether or not the watch-target employee ID has been stored in the notice registration DB 211.

The present processing flow is started when the notice judgment unit 209 receives the notice information from the Agent notice processing unit 208. At a S701, the employee ID and the status value are extracted from the notice received. At a S702, it is judged whether or not the coincidence condition of “status=1 (i.e., at desk)” holds. If this coincidence does not hold (S702: No), the processing flow is terminated. Meanwhile, if this coincidence holds (S702: Yes), at a S703, it is judged whether or not the target record of the employee ID has been stored in the notice registration DB 211. Then, if the target record has been not stored therein (S703: No), the processing flow is terminated. Meanwhile, if the target record has been stored therein (S703: Yes), at a S704, the notice judgment unit 209 instructs the notice transmission unit 210 to transmit a message, then terminating the processing flow. Incidentally, a setting/judgment function for a registration addition condition may also be provided before the S704. For example, only when the utilization state has changed from the screen-saver state to the log-in state, the addition condition such as the notice is set. The setting of an addition condition like this permits only a not-at-desk user to be set as the notice registration target for a short while, or the like.

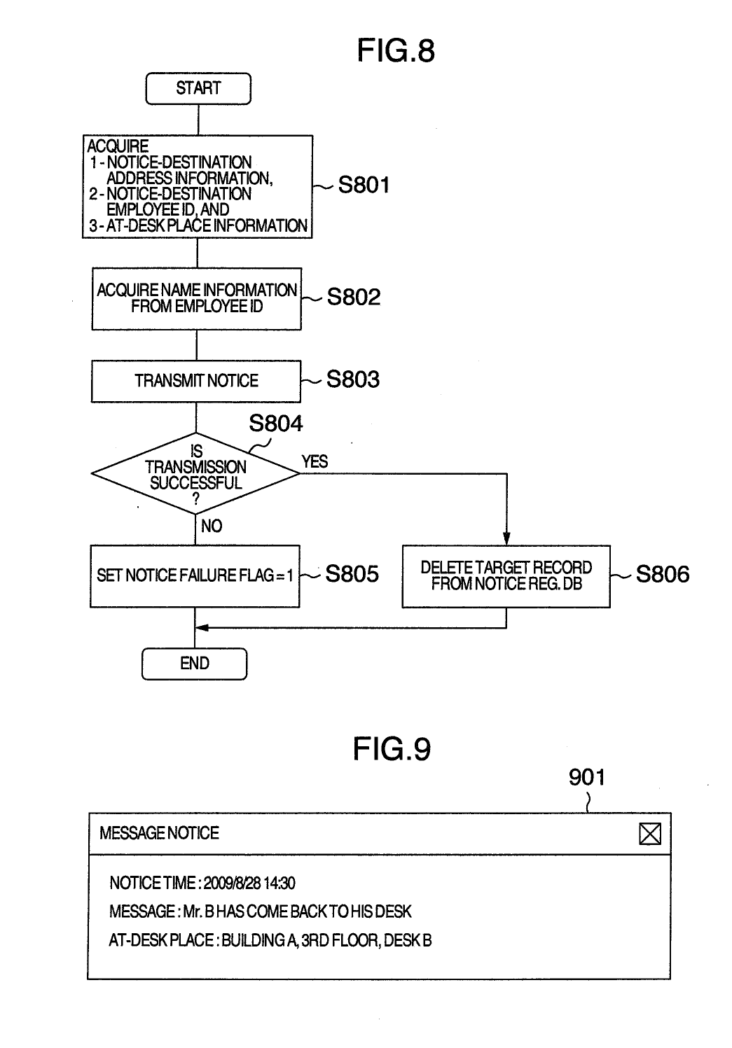

FIG. 8 is a processing flow performed by the notice transmission unit 210 for carrying out the present first embodiment. The notice transmission unit 210 starts this processing flow in accordance with the above-described message-transmitting instruction issued thereto by the notice judgment unit 209 at the S704 in FIG. 7. At a S801, the unit 210 acquires “notice-destination address information”, “notice-destination employee ID”, and “at-desk place information” from the notice judgment unit 209. The notice-destination address information means “MAC address” stored in the at-desk management DB 207. The notice-destination employee ID means “registrant ID” stored in the notice registration DB 211. The at-desk place information means “at-desk place name” stored in the at-desk management DB 207. With respect to the notice-destination address information and the at-desk place information, the unit 210 is allowed to make direct reference to the at-desk management DB 207 in accordance with the instruction at the S704. Also, with respect to the notice-destination address information, the Agent unit 202 may be so configured as to transmit the IP address of its own PC 101. Then, the unit 210 is allowed to take advantage of the IP address information to be stored into the at-desk management DB 207.

At a S802, the notice transmission unit 210 acquires name information from the above-described registrant ID acquired, using the LDAP search unit 213 and the LDAP system 104. Moreover, at a S803, the unit 210 constructs the message data to be transmitted to the notice display unit 201 addressed to “notice-destination address information”, then transmitting a notice of the message data thereto. The notice display unit 201 is configured such that, if the unit 201 receives this notice normally, the unit 201 returns successful-reception indicating information to the notice transmission unit 210. Accordingly, at a 5804, the unit 210 waits for this successful-reception response to be returned thereto. Then, if the unit 210 receives this successful-reception response (S804: Yes), at a S806, the unit 210 deletes the target record from the notice registration DB 211. Meanwhile, if although a certain constant time has elapsed, the unit 210 has failed to receive this response (S804: No), at a 5805, the unit 210 sets “1” into the notice failure flag 503, then terminating the processing.

FIG. 9 is an example of the message screen interface for carrying out the present first embodiment. This message screen is a message-displaying window which is created by the notice display unit 201 at the S803 in FIG. 8. The window 901 is constituted with a text for displaying the notice time, a text for displaying the message contents, and a text for displaying the at-desk place name. These pieces of information need not be the text information. The reception of this message permits the notice registrant to recognize in what place the employee of the watch target ID had fallen into the state of “status=at desk”. In this at-desk state, the registrant finds it possible to make contact with the employee by using, e.g., telephone or instant message (which, hereinafter, will be abbreviated as “IM”).

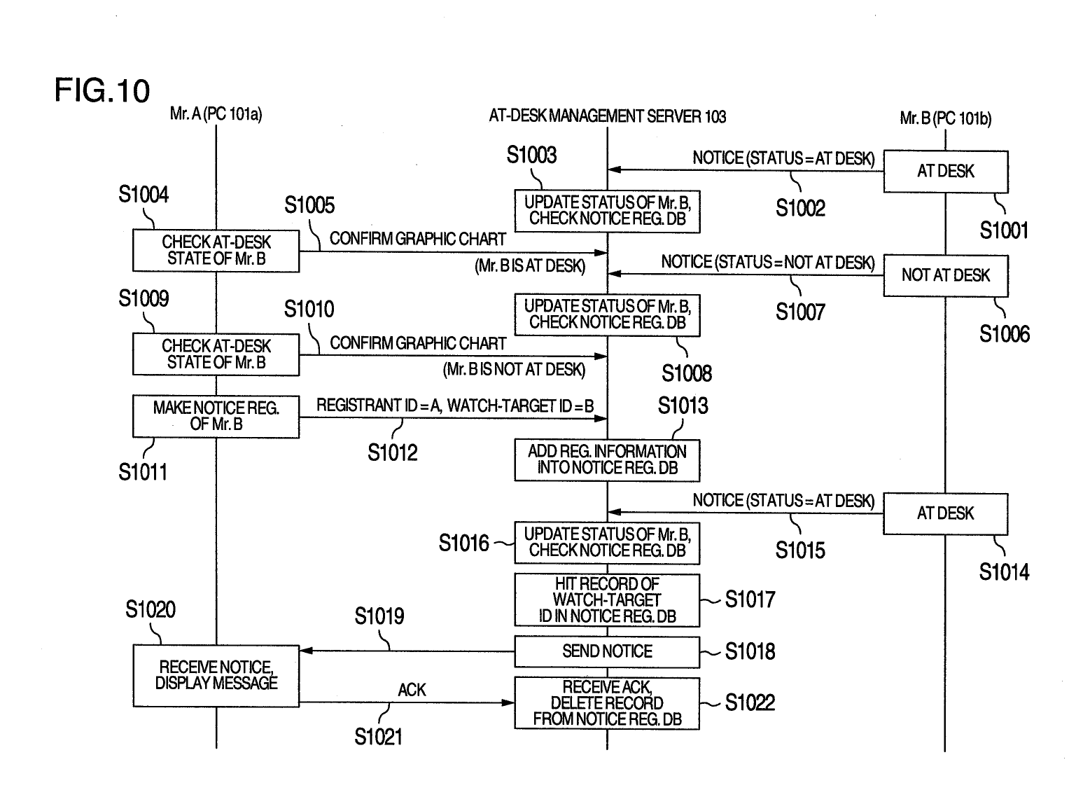

FIG. 10 is a sequence for the utilization scene explained in the present first embodiment. The scene where Mr. A makes the notice registration with respect to Mr. B will be explained in the sequence. Incidentally, hereinafter, the behaviors of Mr. A and Mr. B are implemented in a manner where, actually, the PCs 101a and 101b run by accepting the corresponding operations from Mr. A and Mr. B, i.e., Mr. A and Mr. B do not behave with each other directly.

At a S1001, Mr. B becomes an at-desk state (i.e., log-in state). In response thereto, at a S1002, the Agent unit 202 transmits a notice of “status=1” to the at-desk management server 103. At a S1003, the Agent notice processing unit 208 receives this notice, then registering this reception data into the at-desk management DB 207. Also, the notice judgment unit 209 receives the notice information from the Agent notice processing unit 208, then judging whether or not the watch-target employee ID has been stored in the notice registration DB 211. At this time, however, none of the corresponding record has been stored in the notice registration DB 211. Accordingly, the unit 209 neglects the notice information.

Subsequently, at a S1004, the PC 101a of Mr. A checks the at-desk information on Mr. B. At this time, Mr. B is in the at-desk state. Consequently, at a S1005, making reference to the screen data 216 allows confirmation of this at-desk information. Next, at a S1006, Mr. B leaves the desk, and is away therefrom for a certain constant time. This means that Mr. B becomes a not-at-desk state. As a result, the screen saver is activated. Then, in response to this activation, at a S1007, the Agent unit 202 transmits a notice of status=2″ to the at-desk management server 103.

At a S1008, the Agent notice processing unit 208 receives notice, then registering this reception data into the at-desk management DB 207. Also, the notice judgment unit 209 receives the notice information from the Agent notice processing unit 208. On account of “status=2”, however, the unit 209 neglects the notice information.

Next, at a S1009 and a S1010, Mr. A checks the at-desk information on Mr. B again in trying to give a telephone call to Mr. B. At this time, however, Mr. B is in the not-at-desk state. Accordingly, Mr. A can make the following judgment: “Even if I call Mr. B right now, Mr. B is quite likely to be away from the desk”. Consequently, at a S1011 and a S1012, Mr. A makes the following notice registration, using the registration screen 301 or 401 in FIG. 3 or FIG. 4: Namely, in this registration, Mr. A wishes that, if Mr. B falls into an at-desk state, a notice to the effect should be issued to Mr. A. At a S1013, the notice registration unit 212 registers the registration information into the notice registration DB 211.

Next, at a S1014 and a S1015, Mr. B comes back to the desk, then starting a task with the PC (i.e., Mr. B becomes a log-in state). Accordingly, the Agent unit 202 transmits a notice of “status=1” to the at-desk management server 103. At a S1016, the Agent notice processing unit 208 receives this notice, then registering this reception data into the at-desk management DB 207. Also, at a S1017, the notice judgment unit 209 receives the notice information from the Agent notice processing unit 208, then judging whether or not the watch-target employee ID has been stored in the notice registration DB 211. Here, a record in which Mr. B is registered as the watch-target employee ID has been stored in the notice registration DB 211. Consequently, the notice judgment unit 209 instructs the notice transmission unit 210 to transmit a message,

Next, at a S1018 and a S1019, the notice transmission unit 210 transmits the message to the notice display unit 201 of the PC 101a of Mr. A. At a S1020, the notice display unit 201 of the PC 101a receives the message, then displaying the window 901 in FIG. 9 on the display or the like. Also, at a S1021, the unit 201 sends a successful-reception response to the notice transmission unit 210. At a S1022, the unit 210 receives the successful-reception response from the notice display unit 201, then deleting the target record from the notice registration DB 211.

Thanks to the above-described processing, in the utilization of the at-desk display system, even if a target person, with whom the present function user is going to make contact is found to be “absent” or “not at desk”, the present function user is not required to continue to monitor the graphic chart all the while until the target person has been seated at the desk. Instead of continuing this monitoring, the present function user has only to make the notice registration of the target person. As a result of this notice registration, the reception of the message permits the notice registrant to recognize in what place the employee of the watch target ID had become the state of “status=at desk”. In this at-desk state, the registrant finds it possible to make contact with the employee by using, e.g., telephone or IM.

Incidentally, here, the following embodiment is given: The notice registration is executable only when the at-desk state is “not at desk” or “absent”. Moreover, the notice judgment is made only with an opportunity where the at-desk state changes to “at desk”. It is also possible, however, to expand the configuration of this embodiment as follows: An additional condition, such as <at conference room A> or <at office of B branch>, can be specified at the time of the registration by using, e.g., the screen interface in FIG. 3. In this case, a column for storing the additional condition is added to the notice registration DB 211. Then, if an additional judgment condition is specified in the notice registration DB 211, the additional judgment condition is judged by further making reference to the at-desk management DB 207 after the judgment by the notice judgment unit 209 at the S703. Furthermore, the processing at the S704 is executed only when the coincidence is found to hold.

### Embodiment 2

Next, based on the accompanying drawings, the explanation will be given below concerning a second embodiment of the present invention.

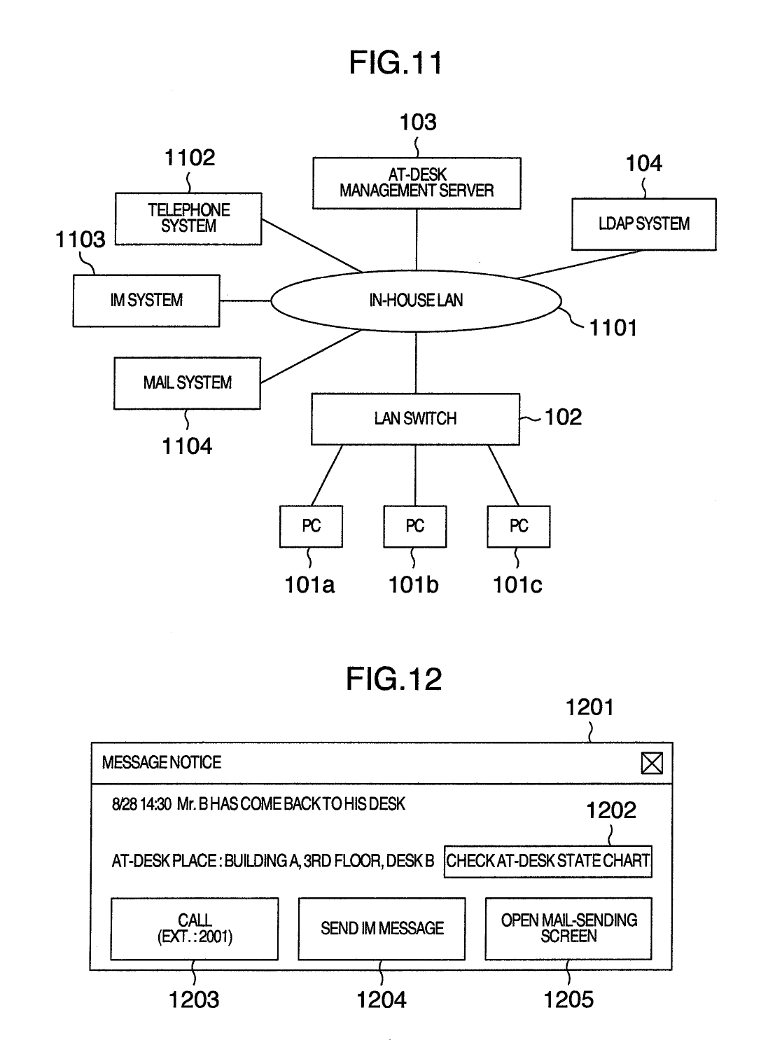

FIG. 11 is a basic communications system configuration diagram for carrying out the present second embodiment. The configuration including a telephone system 1102, an IM system 1103, and a mail system 1104 is added to the configuration in FIG. 1. Also, each system and apparatus are connected to an In-house LAN 1101. Also, the PC 101a to the PC 101c include a client soft or hardware configuration for taking advantage of the telephone system 1102, the IM system 1103, and the mail system 1104.

The telephone system 1102 is a system for implementing a general in-house extension telephone or the like. Concretely, the system 1102 is constituted with a server which is referred to as “IP telephony server”, and client soft which is referred to as “softphone” for the PC 101a to the PC 101c.

The IM system 1103 is a system for implementing the in-house instant messaging. Similarly, the system 1103 is constituted with an IM server, and client soft which is referred to as “IM client” for the PC 101a to the PC 101c.

The mail system 1104 is a system for implementing the general electronic mail. Similarly, the system 1104 is constituted with an electronic-mail server, and client soft which is referred to as “mailer” for the PC 101a to the PC 101c.

FIG. 12 is an example of the message screen interface for carrying out the present second embodiment. As is the case with the window 901 illustrated in FIG. 9, the window 1201 is a screen of which the terminal used by a registrant employee is notified in the processing between the notice transmission unit 210 and the notice display unit 201. With the use of the text, the window 1201 notifies that a watch-target employee registered as the watch target by the registrant employee becomes a specified state. Incidentally, in addition to the text, the notice may also be implemented with the use of graphics or voice.

The point in which FIG. 12 differs from FIG. 9 is a feature that buttons 1202 to 1205 are deployed. The button 1202 is a link interface for displaying the at-desk state chart on the screen. When the notice receiver receives the notice, and pushes down the button 1202, the at-desk state chart screen of a floor on which the watch-target employee is at desk is displayed on the Web browser of the PC 101 from among at-desk state chart screens created by the graphics-drawing unit 214. Then, taking advantage of this at-desk state chart displayed permits the notice receiver to visually specify on which floor and at which desk the watch-target employee is seated.

The button 1203 is a link interface for executing a quick-to-call-based telephone transmission. When the notice receiver receives the notice, and pushes down the button 1203, for example, the softphone constructed inside his or her own PC is booted up in such a manner that the telephone number of the user's transmission destination is functioned as the argument. This scheme permits the notice receiver to execute the telephone transmission to the watch-target employee by one click and without giving a wrong telephone call.

Various types of schemes are conceivable as the pass-over method for the transmission-destination telephone number at the time when the button 1203 is pushed down. An example which is mentionable is the pass-over method based on clipboard conjunction. This clipboard-conjunction-based pass-over method is as follows: The softphone always monitors a commonly-implemented on-OS memory space which is referred to as “clipboard”, thereby monitoring the input of an in-advance-determined magic word (e.g., “C2C-TEL:”) into the clipboard. Also, the softphone is programmed such that, if the softphone finds out this magic word, the softphone will recognize a character string subsequent to <:> as the telephone number, and will transmit this telephone number. Accordingly, writing <C2C-TEL: 2001> into the clipboard when the button 1203 is pushed down allows the softphone to execute the telephone transmission to the telephone number 2001.

The button 1204 is a link interface for booting up the IM client. When the notice receiver receives the notice, and pushes down the button 1204, the IM client constructed inside his or her own PC is booted up in such a manner that the user's destination address is functioned as the argument. This scheme permits the notice receiver to boot up the message-transmitting screen quickly, thereby making it possible to transmit the instant message to the watch-target employee.

The button 1205 is a link interface for booting up the mailer. When the notice receiver receives the notice, and pushes down the button 1205, the mailer constructed inside his or her own PC is booted up in such a manner that the user's destination address is functioned as the argument. This scheme permits the notice receiver to boot up the message-transmitting screen quickly, thereby making it possible to transmit the electronic mail to the watch-target employee.

The above-described functions are provided in such a manner that these functions are combined with the first embodiment. This scheme makes it possible to provide the following series of mechanisms: Namely, these mechanisms allow the notice receiver to receive the notice message, when the watch-target employee becomes “the state where the notice receiver can make contact with the watch-target employee”. This can be performed absolutely regardless of the distinction among the conference room, the same floor, and a floor of another building. Moreover, these mechanisms allow the notice receiver to easily select “the next action” from the notice message.

Concretely, the present second embodiment makes it possible to provide the following information or functions, which lead to the determination of “the next action” to be taken by the user who browses the message window 1201 in FIG. 12: Namely, if the user wishes to meet the target person directly to have a conversation with him or her, it is possible to visually display, on the at-desk state chart, the at-desk position at which the target person is seated. If the user wishes to give a telephone call to the target person, it is possible to display the telephone-number information on the target person, and to provide the quick-to-call-based telephone transmission function. If the user wishes to make contact with the target person by the instant message, it is possible to provide the function of immediately opening the IM-dedicated message-transmitting screen to the target person. If the user wishes to make contact with the target person by the electronic mail, it is possible to provide the function of immediately opening the electronic-mail-dedicated message-transmitting screen to the target person.

In this way, even if the user has been notified of a change in the state of the target person, “the next action” to be taken by the user becomes different in many cases. This is because “the next action” depends on, e.g., the residential place of the target person, or the position relationship between the target person and the user. According to the present second embodiment, it becomes possible to smooth the communications by presenting, as selective options, the appropriate actions which are appropriate for the notice of the change in the state of the target person.

### Embodiment 3

Next, based on the accompanying drawings, the explanation will be given below concerning a third embodiment of the present invention.

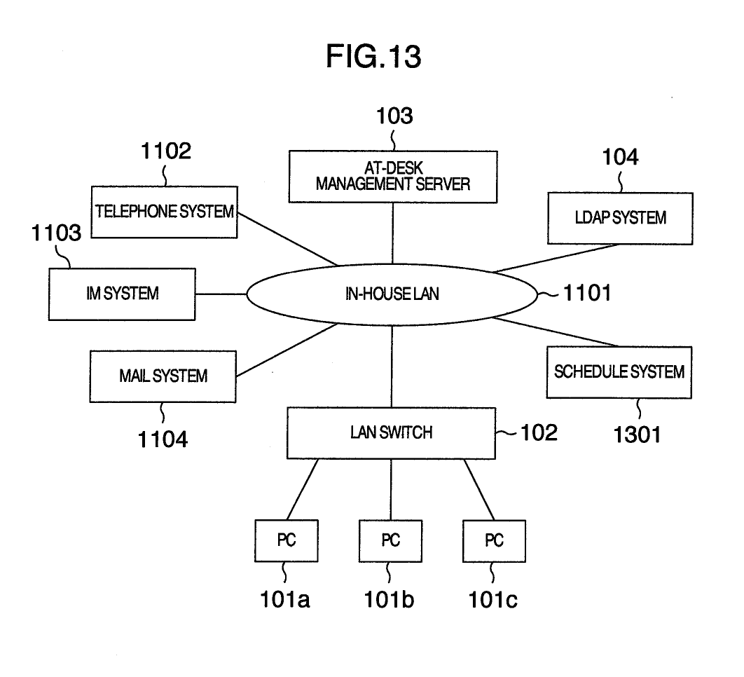

FIG. 13 is a basic communications system configuration diagram for carrying out the present third embodiment. A schedule system 1301 is added to the configuration illustrated in FIG. 11.

The schedule system 1301 is a system for implementing a general intra-enterprise employee schedule. The schedule system 1301 may be a single server, or may be integrated into the at-desk management server 103 as its function. Although various types of conjunctions are implementable with the schedule system 1301, the description will be given here regarding a conjunction embodiment with the schedule system 1301 which is equipped with a URL-based Web interface.

The URL-based Web interface is the following interface: This interface makes the utilization of the schedule system 1301 implementable via a Web screen of the schedule system 1301. Furthermore, this interface makes it possible to directly display the user screen of an employee ID by accessing the Web screen of the schedule system 1301 such that the argument such as the employee ID is attached to a URL for accessing the Web screen of the schedule system 1301. This URL-based Web interface will be explained below, using the following concrete example: When the URL for accessing the Web screen of the schedule system 1301 is “http://www.schedulesystem.do”, the user ID of <Mr. A> registered into the schedule system 1301 is “200”. In this case, inputting the URL of (1) “http://www.schedulesystem.do?user-id=200” into this URL-based Web interface allows this interface to directly display the schedule screen of <Mr. A>.

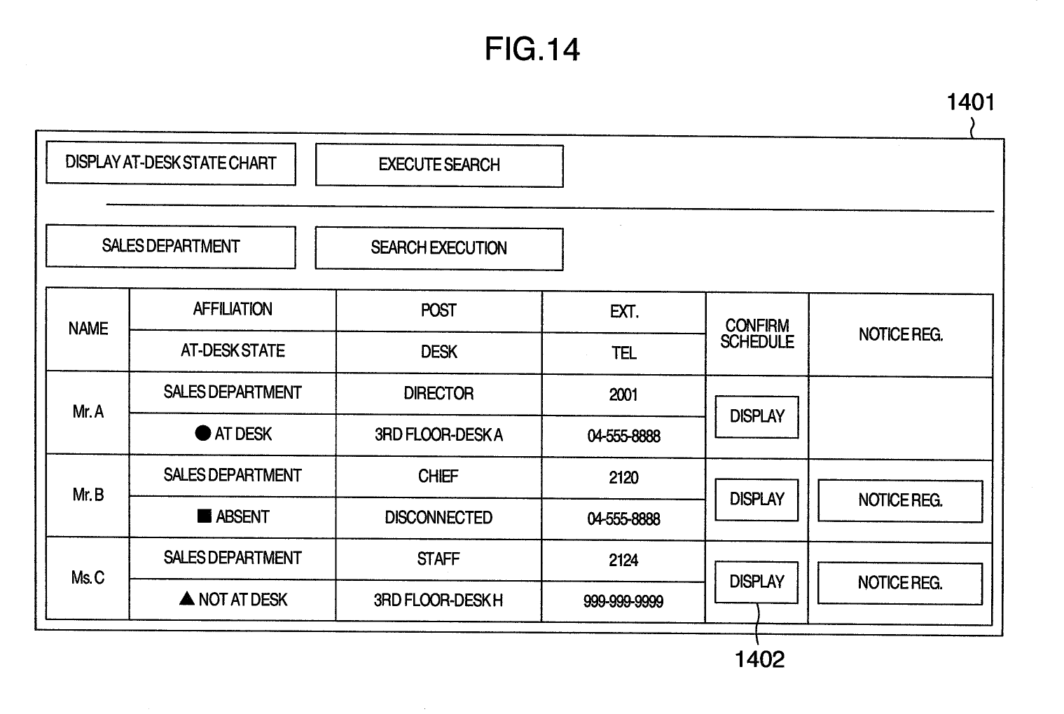

FIG. 14 is an example of the screen interface for carrying out the present third embodiment. Its feature is that schedule-displaying buttons 1402 are added to the screen interface in FIG. 3 displayed in the at-desk management system. The other configuration components are basically the same as in the embodiment in FIG. 3.

Pushing down the schedule-displaying button 1402 causes information to be passed over to the Web browser soft. Here, this information is constructed in such a manner that the watch-target employee ID of a row where the schedule-displaying button 1402 is displayed is set into the URL information of the above-described notation (1). Then, by taking advantage of the URL-based Web interface exemplified in the above-described notation (1), the Web browser soft displays, onto the screen of the user, the schedule screen of the target person with whom the user wishes to make contact. This display of the schedule screen of the target person permits the user to execute a notice registration processing which is fitted to the schedule of the target person. An example of this kind of fitted notice registration processing is as follows: “The target person is away from the desk just a while for an arrangement meeting. So, I'll make a notice registration of the target person.”, or “The target person is unlikely to get back for a business trip. So, I won't make a notice registration of the target person.”

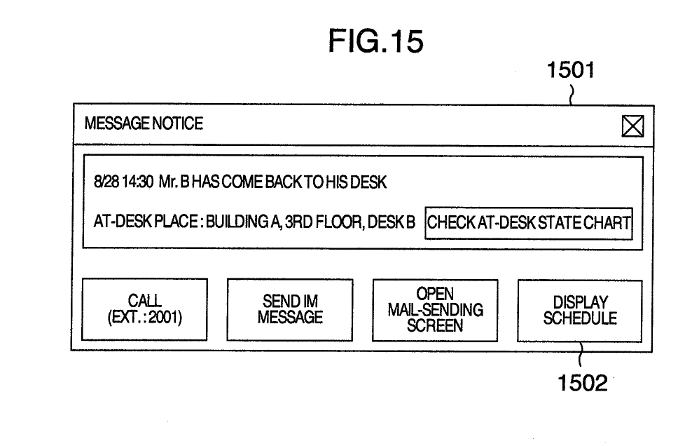

FIG. 15 is an example of the message screen interface for carrying out the prey third embodiment. The window 1501 is the same message screen interface as the one illustrated in FIG. 12. Namely, the window 1501 is the message screen interface of which the terminal used by the registrant employee is notified in the processing between the notice transmission unit 210 and the notice display unit 201. Moreover, the information or functions described in the second embodiment, which lead to the determination of “the next action”, are displayed on the window 1501. Here, a feature of the window 1501 is that a schedule-displaying button 1502 is deployed thereon.

The schedule-displaying button 1502 is a link interface for executing basically the same processing as the schedule-displaying buttons 1402. When the notice receiver pushes down the schedule-displaying button 1502, the above-described information is passed over to the Web browser soft. Here, this information is constructed in such a manner that the watch-target employee ID is set into the URL information of the above-described notation (1). Then, by taking advantage of the interface exemplified in the above-described notation (1), the Web browser soft displays, onto the screen of the user, the schedule screen of the target person with whom the user wishes to make contact.

According to the above-described configuration, in the presence systems and communications systems the representative of which is the at-desk management system, it becomes possible to provide the following mechanism: Namely, this mechanism permits a user to easily grasp not only the present time schedule information on a target person with whom the user wishes to make contact, but also the immediately-before schedule and from-now-on schedule of the target person.

Concretely, if the target person with whom the user wishes to make contact is found to be absent, in FIG. 14, the user displays the schedule screen of the target person by pushing down the schedule-displaying button 1402. Then, if the target person is scheduled to get back from a business trip in about 30 minutes from now on, the user can make the following notice registration, using the function of the notice registration button: “When the target person comes back to the company, and falls into a state where I can make contact, please let me know.” Otherwise, if the target person is scheduled to go around to visit the company's regular clients until evening today, the user can make a judgment saying “Then, why don't I send only the business by mail or something like that?”.

Also, if the notice is issued to the user to the effect that the target person with whom the user wishes to make contact becomes the state where the user can make contact, in FIG. 15, the user displays the schedule screen of the target person by pushing down the schedule-displaying button 1502. Then, if the user has confirmed that, for example, the target person is scheduled to attend a conference in 5 minutes from now on, the user can make a judgment saying “Then, anyway, why don't I send only the business to the target person by IM?”. Otherwise, if the user has confirmed that the target person is not scheduled at all from now on, the user can make a judgment, such as “I'll walk to the at-desk position of the target person. Then, probably, I'll be able to have a settled-down conversation for a long time directly.”.

It should be further understood by those skilled in the art that although the foregoing description has been made on embodiments of the invention, the invention is not limited thereto and various changes and modifications may be made without departing from the spirit of the invention and the scope of the appended claims.

1. An at-desk notice system, comprising:
a plurality of clients; and
a server, wherein
each of the plurality of clients comprises
a notice display unit for displaying at-desk notice information on a monitoring-target user; and
a state notice unit for notifying the server of a change in state information on a user who uses the client,
the server comprising
a judgment unit for judging whether the state information, a change of which is notified by one of the clients, has changed to an at-desk state and whether a user of the change-notified client is monitored by other user; and
a notice unit for issuing, to the client of the other user, a notice that a monitoring-target user becomes the at-desk state.

2. The at-desk notice system according to claim 1, wherein, when a monitoring condition is further set by the other user who monitors the at-desk notice information,
the judgment unit judges whether or not the at-desk notice information notified satisfies the monitoring condition, and,
when the at-desk notice information is found to satisfy the monitoring condition, the judgment unit causes the notice unit to issue the notice that the monitoring target user becomes the at-desk state.

3. The at-desk notice system according to claim 2, wherein
the notice display unit of any one of the clients displays name of the monitoring-target user, building name and floor on which the monitoring-target user is present, and at-desk place at which the monitoring-target user is seated on the floor.

4. The at-desk notice system according to claim 3, wherein, if a user logs-in to the client,
the state notice unit of the client judges that the change in the state information on the user has become the at-desk state, and
the state notice unit then notifies the server of the change in the state information indicating that the user becomes the at-desk state.

5. The at-desk notice system according to claim 3, wherein
the notice display unit of any one of the clients displays the building name and the floor on which the monitoring-target user is present, and the at-desk place at which the monitoring-target user is seated on the floor, and also, contact means for making contact with the monitoring-target user.

6. The at-desk notice system according to claim 3, wherein
a link for displaying an at-desk state chart is set into the displayed contents displayed by the notice display unit.

7. The at-desk notice system according to claim 5, wherein
the contact means is telephone, instant messenger, or mail.

8. An at-desk notice server connected to a plurality of clients, comprising:
a judgment unit for judging whether the state information, a change of which is notified by one of the clients, has changed to an at-desk state and whether a user of the change-notified client is monitored by other user; and
a notice unit for issuing, to the client of the other user, a notice that a monitoring-target user becomes the at-desk state.

9. The at-desk notice server according to claim 8, wherein, when a monitoring condition further set by the other user who monitors the at-desk notice information,
the judgment unit judges whether or not the at-desk notice information notified satisfies the monitoring condition, and,
when the at-desk notice information is found to satisfy the monitoring condition, the judgment unit causes the notice unit to issue the notice that the monitoring-target user becomes the at-desk state.

10. The at-desk notice server according to claim 9, wherein
the notice unit issues the notice which includes name of the monitoring-target user, building name and floor on which the monitoring-target user is present, and at-desk place at which the monitoring-target user is seated on the floor.

11. The at-desk notice server according to claim 8, further comprising;
a screen-displaying function unit for causing the clients to display enrollment situation of registered users by a floor map, and accepting a monitoring registration of the at-desk state of a user selected on the floor map.

12. The at-desk notice server according to claim 11, wherein
the screen-displaying function unit displays the floor map which includes a desk used by a user who is searched by a user search function.

13. A client equipped with an at-desk notice function, comprising:
a notice display unit for displaying at-desk notice information on a monitoring-target user; and
a state notice unit for notifying a change in state information on the a user who uses the client.

14. The client according to claim 13, wherein
the notice display unit of the client displays name of the monitoring-target user, building name and floor on which the monitoring-target user is present, and at-desk place at which the monitoring-target user is seated on the floor.

15. The client according to claim 14, wherein
if the user logs-in to the client,
the state notice unit of the client judges that the user becomes an at-desk state, and
the state notice unit then notifies the server of the change in the state information indicating that the user becomes the at-desk state.

16. The client according to claim 14, wherein
the notice display unit of the client displays the building name and the floor on which the monitoring-target user is present, and the at-desk place at which the monitoring-target user is seated on the floor, and also, contact means for making contact with the monitoring-target user.

17. The client according to claim 14, wherein
a link for displaying an at-desk state chart is set into the displayed contents displayed by the notice display unit.

18. The client according to claim 16, wherein
the contact means is telephone, instant messenger, or mail.
